(19) United States
(12) Patent Application Publication
(10) Pub. No.: US 2003/0023855 A1
(43) Pub. Date: Jan. 30, 2003

(54) High security storage unit and biometric entry system

(76) Inventors: Kyle Dana Keogh, Lake Mary, FL (US); Colin Robert Keogh, Casselberry, FL (US)

Correspondence Address: Scott L. Terrell, 1746 Cole Boulevard, #225, Golden, CO, 80401, US

(21) Appl. No.: 10/185,453

(22) Filed: Jun. 28, 2002

Related U.S. Application Data
(60) Provisional application No. 60/302,154, filed on Jun. 29, 2001.

(51) Int. Cl. H04L 9/00

(52) U.S. Cl. 713/186

(57) ABSTRACT

A high security portable storage unit having a digital biometric device as its sole means of gaining access is provided which includes a box having two sides, a front, a back, a top and a bottom walls, at least one of the walls having a hinged access panel to an interior of the box; a fingerprint reading device; an electronic locking mechanism connected to an inner surface of one of the walls including at least one rod slidably connected to the hinged panel, an electronically controlled mechanism for positioning the rod in a retracted or extended position relative to the hinged panel, whereby access to the interior of the box is denied when the rod is in the extended position and access is allowed when in the rod is in the retracted position; and a digital processing board for converting a fingerprint image to a digital image data, extracting minutia data from the image data, comparing the minutia data to that of an authorized user, verifying the compared data, and actuating the electronic locking mechanism.

### CROSS REFERENCE TO RELATED APPLICATIONS

Pursuant to 35 U.S.C. 119(e) Applicant hereby claims the benefit of U.S. Provisional Application Ser. No. 60,302,154, filed Jun. 29, 2001.

### BACKGROUND OF THE INVENTION

1. Field of the Invention.

The present invention relates to safe storage systems. In particular, it relates to a biometric access control unit.

2.Description of the Related Art.

Each year over 100,000 handguns are stolen; hundreds are killed in handgun accidents; thousands use their handgun to protect themselves and their property. Each year, thousands of children are poisoned by their parents medicine. Each year, billions of dollars worth of valuable merchandise is stolen from victim's homes.

This invention relates to the safe storage of items that need to be secured in a high security methods while allowing the authorized users immediate access. Previous safe storage units have used a variety of access methods. These access methods have evolved over the years, however the security of the stored items has not increased with the access methods. Some safe storage units use a key for access that can be easily picked or drilled. Some safe storage units use a mechanical tumbler that is easily breached.

The next generation was the electronic entry system that used a mechanical override. For example, U.S. Pat. No. 5,794,466 to Hungerford, et al discloses a gun safe using a fingerprint access method with a mechanical override. While this invention demonstrates some utility it circumvents the added security a fingerprint reader represents by adding a mechanical override. The safe also uses a digital photographic image of the fingerprint to store and compare for access. This method allows for possible tampering and unauthorized entry. While the electronic entry system was more secure, the security is only as secure as its weakest link. With an override system, the electronic entry system could be easily defeated.

In the example of firearms, there are numerous methods of secure storage. Yet none of the storage methods provide a high security storage with easy and fast access. A gun lock does not protect the gun from being stolen. It also is cumbersome when the authorized user needs to access and use it in an emergency. A safe will secure the firearm from being stolen, but again it is cumbersome to access when the firearm is needed quickly.

While the foregoing provides for safe storage there is still a need for a highly secure storage unit that is easy and rapid in access. Our invention satisfies these needs. It provides for a highly secure device whereby only authorized users have access to it's contents by fingerprint in less than a second.

### BRIEF SUMMARY OF THE INVENTION

It is therefore a principal object of the present invention to provide a high security safe which can not be easily overridden, but which allows for the easy and rapid method of access for only it's authorized users.

To overcome the problems of the prior art methods and in accordance with the purpose of the invention, as embodied and broadly described herein, briefly, a high security portable storage unit having a digital biometric device as its sole means of gaining access is provided which includes a box having two sides, a front, a back, a top and a bottom walls, at least one of the walls having a hinged access panel to an interior of the box; a fingerprint reading device; an electronic locking mechanism connected to an inner surface of one of the walls including at least one rod slidably connected to the hinged panel, an electronically controlled mechanism for positioning the rod in a retracted or extended position relative to the hinged panel, whereby access to the interior of the box is denied when the rod is in the extended position and access is allowed when in the rod is in the retracted position; and a digital processing board means for converting a fingerprint image to a digital image data, extracting minutia data from the image data, comparing the minutia data to that of an authorized user, verifying the compared data, and actuating the electronic locking mechanism.

Additional advantages of the present invention will be set forth in part in the descriptuion that follows and in part will be obvious from that description or can be learned from practice of the invention. The advantages of the invention can be realized and obtained by the apparatus particularly pointed out in the appended claims.

### BRIEF DESCRIPTION OF THE SEVERAL VIEWS OF THE DRAWINGS

The accompanying drawings, which are incorporated in and which constitute a part of the specification, illustrate at least one embodiment of the invention and, together with the description, explain the principles of the invention.

FIG. 1. is a view of the storage unit and the inside of the door.

FIG. 2 is a front view of the storage unit.

FIG. 3 is a view of the locking mechanism for the storage unit.

### DETAILED DESCRIPTION OF THE DRAWINGS

Unless specifically defined otherwise, all technical or scientific terms used herein have the same meaning as commonly understood by one of ordinary skill in the art to which this invention belongs.

Although any methods and materials similar or equivalent to those described herein can be used in the practice or testing of the present invention, the preferred methods and materials are now described. Reference now will be made in detail to the presently preferred embodiments of the invention, examples of which are illustrated in the accompanying drawings.

A high security storage unit using a single method of entry, an electronically read fingerprint, to secure the storage unit, includes of a top, bottom, sides, front and back. The front face is hinged to allow it to open and close. Also included is an electronic mechanism that contains one or more sliding rods that secure the front face in a locked position. Also provided is a fingerprint scanning device that is located on the exterior of the vault that detects and processes the presence of a fingerprint. This fingerprint scanning device also allows the entry of one or more digital fingerprint templates to be entered into the memory of the fingerprint scanning device as authorized users. This device is also used for verification of authorized users and can send a signal to the electronic locking mechanism upon verification of an authorized user.

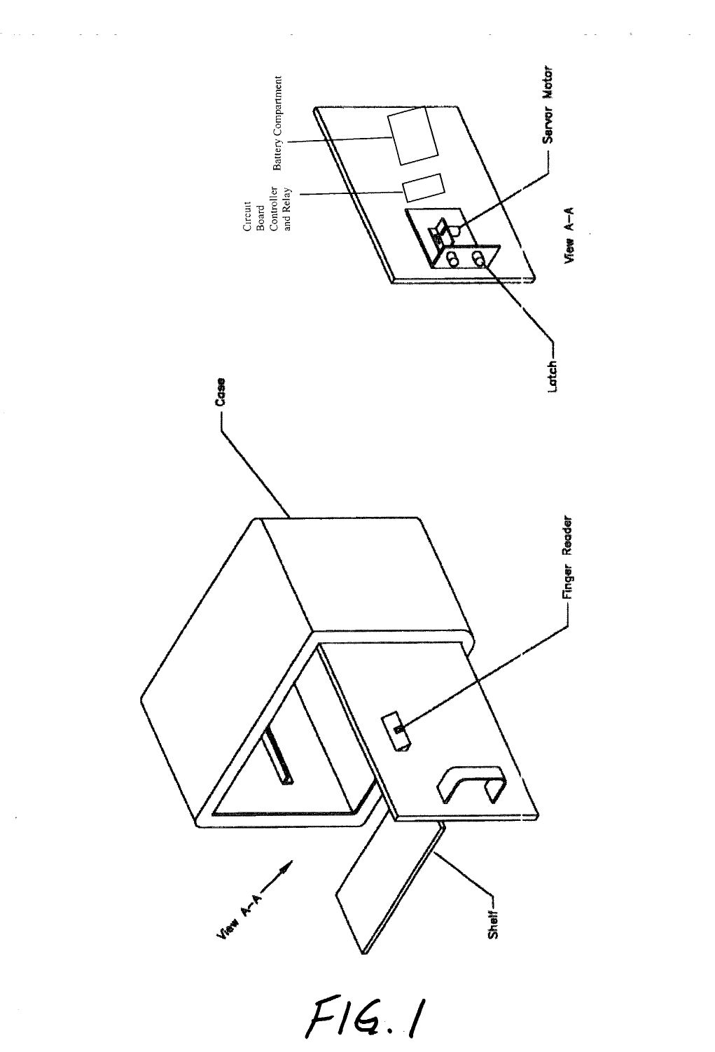

FIG. 1 contains a line drawing of the high security storage unit and inside the door. This unit is constructed of 18 gauge steel on each side, top and bottom and do. The steel has been constructed to the door is offset to the inside by one half inch to thwart prying of the door. The door is hinged on the right side as a person is facing the door. The position of the hinge can be moved depending on the final application. On the left side of the door in FIG. 1 there is a double bolt system that is contorolled by a servo motor. In the top middle of the door is a slot for the wires from the biometric fingerprint reader to connect to the relay board located on the inside top middle of the door. Also located on the middle right of the door I the battery pack that provides the power to the locking mechanism and the fingerprint reader.

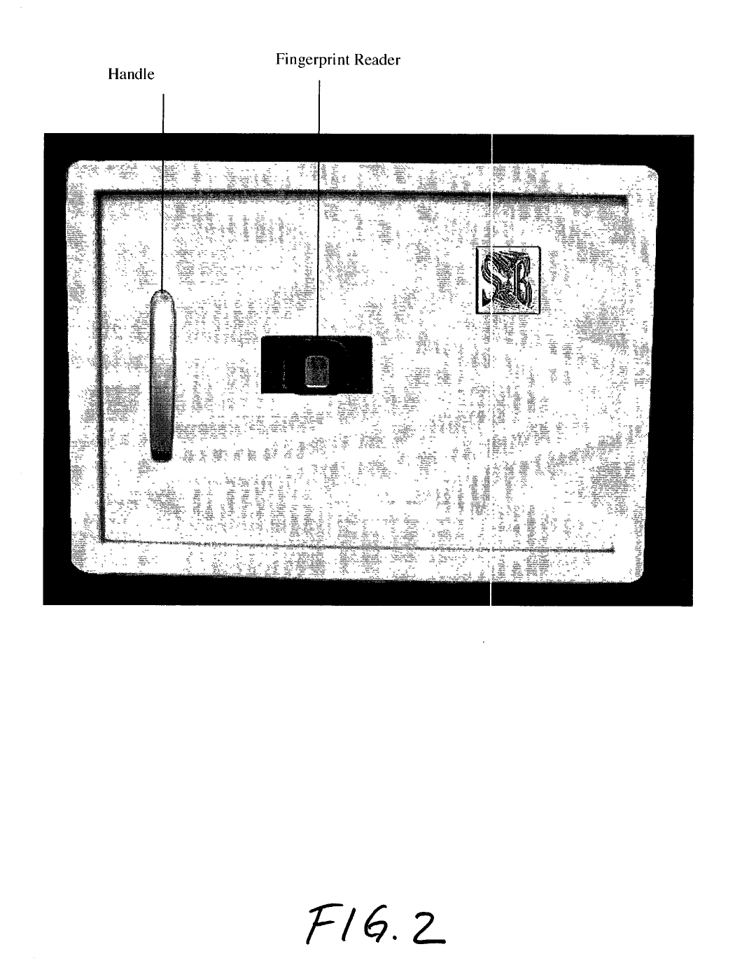

FIG. 2 is a picture of the outside front of the door. On the front left is the handle to pull open the door and in center is the biometric fingerprint reader.

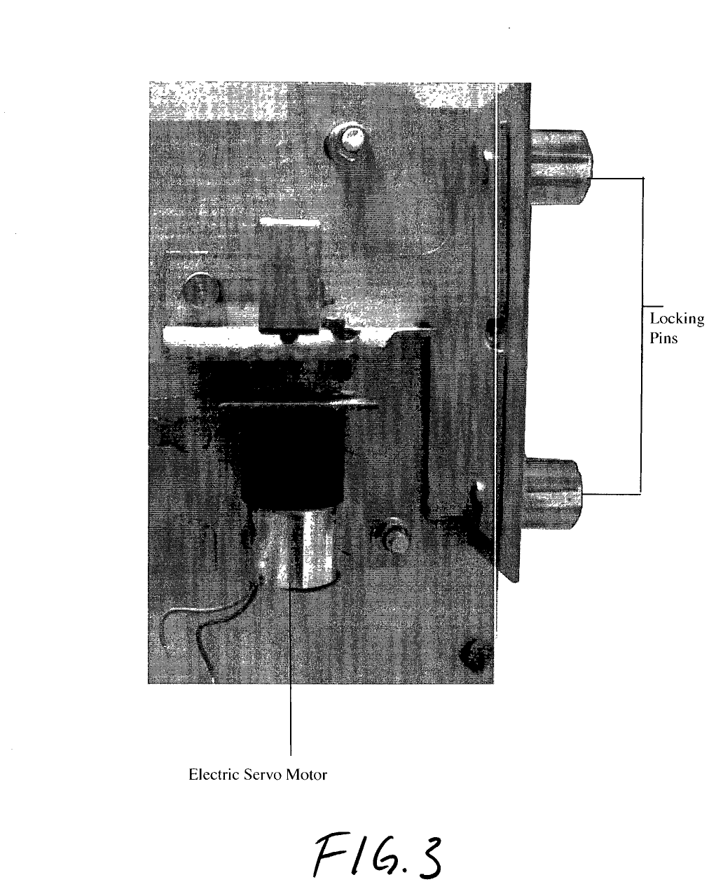

FIG. 3 is a picture of the locking mechanism on the inside of the door. This mechanism has a motor that moves the two locking pins in and out. The motor is activated by a relay attached to the fingerprint reader board. When the finger is placed on the board and verified as an authorized user, the board sends a signal to the relay which in turn allows electricity to be sent to the motor. This electric signal will either open or close the locking pins.

In operation, one uses the storage unit to secure items in a high security method. Mounted on the inside of the unit are three buttons, the first button allows the person to enroll their fingerprint into the memory of the fingerprint reader. The whole fingerprint is not stored, the algorithm chooses minutiae points from the fingerprint points from the fingerprint and stores them as a template in memory. After the template is sored the enrolle then presses the second button.

By pressing the second button, the enrollee puts the fingerprint reader into verification mode. In this mode the enrollee can place their finger on the reader and when it is verified as an authorized fingerprint, the verification unit sends a signal to the relay then allows electricity to flow to the motor that drives the

When electricity is sent to the locking pins, it unlocks or locks the safe. You must use your fingerprint to both lock and unlock the safe.

While the present invention has been described in connection with the illustarted emboidments, it will be appreciated and understood that modifications may be made without departing from the true spirit and scope of the invention.

I claim:

1. A high security portable storage unit having a digital biometric device as its sole means of gaining access, comprising:
(a) a box having two sides, a front, a back, a top and a bottom walls, at least one of the walls having a hinged panel for access to an interior of the box;
(b) a fingerprint reading device;
(c) an electronic locking mechanism connected to an inner surface of one of the walls including at least one rod slidably connected to the hinged panel, an electronically controlled mechanism for positioning the rod in a retracted or extended position relative to the hinged panel, whereby access to the interior of the box is denied when the rod is in the extended position and access is allowed when in the rod is in the retracted position; and
(d) a digital processing board means for converting a fingerprint image to a digital image data, extracting minutia data from the image data, comparing the minutia data to that of an authorized user, verifying the compared data, and actuating the electronic locking mechanism.

2. The storage unit according to claim 1 further comprising an electronic proximity sensor means for powering up the reading device as a finger approaches the reader thereby reducing a power consumption for operation over an extended length of time.

3. The secure storage device according to claim 2 further comprising an enrollment system for registered users that is self contained within the storage device.

4. The storage unit according to claim 2 further comprising an additional layer of security by encrypting a users fingerprint on an electronic card and said card is used to enroll authorized fingerprints.
